(19) United States
(12) Patent Application Publication
(10) Pub. No.: US 2009/0164258 A1
(43) Pub. Date: Jun. 25, 2009

(54) SYSTEM AND METHOD FOR SELLING INSURANCE PRODUCTS

(75) Inventor: Maximilian Nicholas Broodryk, Wentworthville (AU)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 12/340,197

(22) Filed: Dec. 19, 2008

(30) Foreign Application Priority Data
Dec. 21, 2007 (AU) 2007101215

(51) Int. Cl. G06Q 40/00

(52) U.S. Cl. 705/4

(57) ABSTRACT

A system and method for selling insurance products online is described. The system and method allow a provider to sell insurance products to a customer, either directly or through a broker or aggregator, whereby a single GUI is used for all insurance products sold and the customer only has to enter their personal details once when purchasing multiple insurance products.

### CLAIM OF FOREIGN PRIORITY

This patent application claims the benefit of priority to Australian Innovation Patent Application No. 2007101215, filed Dec. 21, 2007, entitled “System and Method for Selling Insurance Products” which is incorporated by reference.

### FIELD OF THE INVENTION

The present invention is generally related to selling insurance products, but more specifically, to a computer implemented system and method for selling multiple insurance products.

### BACKGROUND

Insurance product providers or underwriters, hereafter referred to as “providers,” are continually seeking more effective methods for selling insurance products to customers. To do so, providers require user friendly methods for selling insurance products in order to reduce customer frustration.

Typically, insurance product purchasers, requesters or customers, hereafter referred to as “customers,” find the process of buying insurance products complex and frustrating.

This is illustrated in the example where a customer purchases business insurance via the Internet. In the first step, the customer may begin by using search engines to identify websites that provide cover. The customer may be directed to a website of an insurance product provider, a website of an insurance broker, hereafter referred to as a “broker,” which resells insurance from insurance product providers, or the website of an “aggregator” which collates information about insurance products from one or more insurance providers.

Once the customer has navigated to one of these sites and chooses to obtain a quotation for business cover, the customer is required to enter a large amount of information about the business they wish to insure. The information required may include financial details about the business, details of the insurance product and limit or sum insured options, risk exposure information, business category, the business trade, the names of directors and the address of the business or other contact information. It is evident that some of the required information is unrelated to the quotation amount. For example, contact information such as an email address does not have an effect on the insurance premium. Often, when a customer is faced with the task of providing a large amount of information in order to receive a quote, the customer will look for another provider, resulting in a potential loss of sale for the provider, broker or aggregator.

Assuming, in this example, that the customer perseveres and submits all of the required information, the provider, broker or aggregator will then be required to forward the customer information to the provider's underwriting department to determine the quotation amount for the customer. This is often the case where the customer has requested a large amount of cover and the provider is required to perform the necessary background checks in order to determine if the risk is acceptable or not. The customer may receive an instruction via the website that the quotation amount will be forwarded to their email address when ready.

The time required by the underwriting department to determine the quotation amount will take from a matter of days to weeks depending on the cover requested. Typically, the customer will not be prepared to wait this long to receive a quotation amount. Further, should the underwriting department decide not to provide cover in light of an unacceptable risk and inform the customer that the cover has been declined, the customer has effectively wasted time which could have been spent searching for insurance cover from other avenues.

The current insurance industry has attempted to overcome the delay experienced when requesting authority from the underwriting department by using the concept of a “cover note.” A cover note provides a broker the authority to bind cover for a limited period on the provider's behalf. However, the cover note is open to abuse as unscrupulous brokers are able to bind cover after an incident has already taken place. A further disadvantage of the cover note system is that the provider does not realize the risk to which it is exposed for weeks or months until the cover note is returned to the provider.

FIG. 1 shows a typical interaction process 100 between an insurance provider 105, an insurance broker 110 and a customer 115 in which the customer 115 requests a (commercial) insurance product. The process 100 starts at 120 where the customer 115 requests a broker 110 to produce quotation for an insurance product. At step 125 the broker 110, in response to the request 120, enquires of further information from the customer 115. This information may include, but is not limited to, personal details about the customer 115 and other information pertaining to the customer's risk profile. At step 130 the customer 115 replies to the broker's query by providing the requested information. However, at this stage the broker 110 is not in a position to provide a quotation nor bind the requested insurance product. Thus, at step 135 the broker 110 provides the information to the provider 105. The provider 105 then assesses the information to determine whether to provide the insurance product or not. If the provider 105 decides to offer the product, the pricing for the insurance product is also decided. At step 140 the provider 105 provides the decision and pricing information back to the broker 110. At step 145 the broker forwards the information on to the customer.

FIG. 2 shows a schematic example of the current system 200 of selling insurance products where multiple interfaces exist for multiple insurance products. The system 200 comprises a plurality of insurance products 205 and a plurality of insurance product interfaces 210. Each insurance product 215, 220, 225 is associated with a unique interface 230, 235, 240 respectively. The information entered into each interface 230, 235, 240 is not shared amongst the interfaces, requiring the customer 115 to enter certain information more than once.

A further disadvantage of the current methods of selling insurance products is that different jurisdictions have customer, product, legal and tax differences. This significantly increases complexity and has the effect of requiring separate online systems to be built, or substantially re-built, in different countries or territories.

### BRIEF SUMMARY OF THE INVENTION

There is provided a system and method for selling insurance products online. The system and method allow a provider to sell insurance products to a customer, either directly or through a broker or aggregator, whereby a single graphical user interface (GUI) is used for all insurance products sold, and the customer only has to enter their personal details once when purchasing multiple insurance products.

According to one aspect, there is provided a computer implemented method of selling an insurance product comprising the steps of receiving a first request comprising data pertaining to a first insurance product, processing the first request to determine data related to the first insurance product, outputting a response comprising the data related to the first insurance product to be inserted into the data fields of a graphical user interface, receiving a second request comprising data pertaining to a second insurance product, processing the second request to determine data related to the second insurance product and outputting a response comprising the data related to the second insurance product to be inserted into the data fields of the graphical user interface.

According to another aspect, there is provided a computer implemented method for selling a plurality of insurance products comprising the steps of receiving a request pertaining to an insurance product from a single user interface arising from a corresponding request to the single user interface, processing the request, repeating these steps for each of at least one further insurance product from a single user interface arising from a corresponding request to the single user interface, receiving data entered via the single user interface, the data pertaining to specific details of an intended policy holder common to each insurance product, and outputting a response to the single user interface, the response arising from the processing of the requests and the received data, the response comprising quotation data pertaining to each product.

According to a further aspect, there is provided a graphical user interface for facilitating at least a quotation to a customer of multiple insurance products comprising means for customer selection of plural insurance products, means for customer entry of limited risk criteria associated with each selected product, means for transmitting data associated with the selected products and limited criteria to a remote server, means for receiving from the remote server and simultaneously representing to the customer a quote for each selected product and means by which the customer can enter customer details and payment details to accept at least one of the quotes.

### BRIEF DESCRIPTION OF THE SEVERAL VIEWS OF THE DRAWINGS

At least one embodiment of the present invention will now be described with reference to the drawings, in which:

FIG. 1 shows the steps of a prior art process where a customer requests an insurance product;

FIG. 2 represents a prior art system of selling insurance products where each insurance product is represented by a unique insurance product interface;

FIG. 3 shows a system of using a single graphical user interface to provide quotations for insurance products or sell insurance products;

FIG. 4 shows, schematically, a system for providing insurance products online;

FIG. 5 shows steps of a process where a customer purchases an insurance product;

FIGS. 6A, 6B, 6C and 6D are flowcharts of the methods of customer insurance purchasing;

FIG. 7 shows the system for selling insurance products using a single interface;

FIGS. 8A to 8J show examples of a graphical user interface for providing one or more insurance products online;

FIG. 9 is a schematic block diagram of a general purpose computer upon which arrangements described can be practiced;

FIGS. 10A to 10D show examples of a graphical user interface for providing one or more insurance products online; and

FIG. 11 shows another system of using a single graphical user interface to provide quotations for insurance products or sell insurance products.

### DETAILED DESCRIPTION OF THE INVENTION

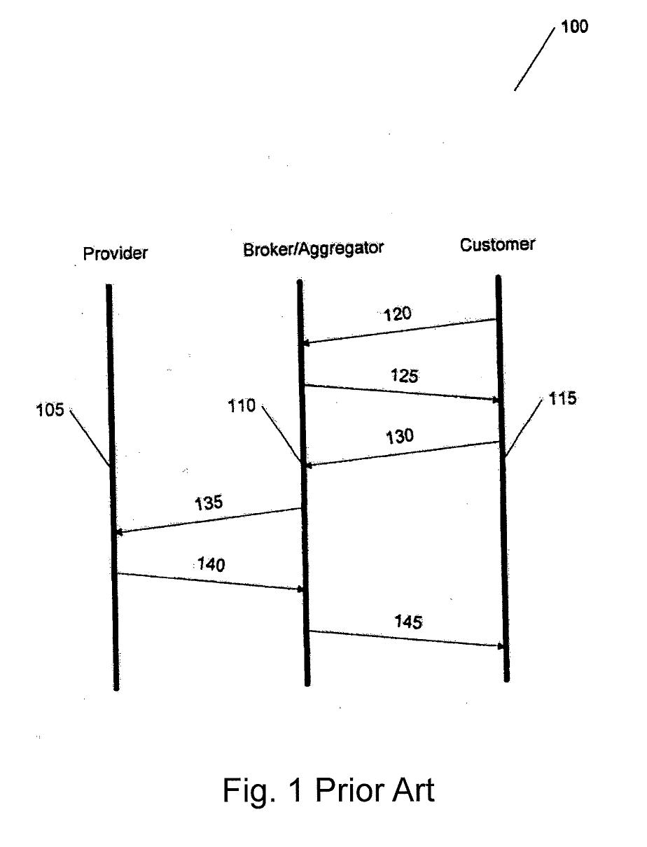

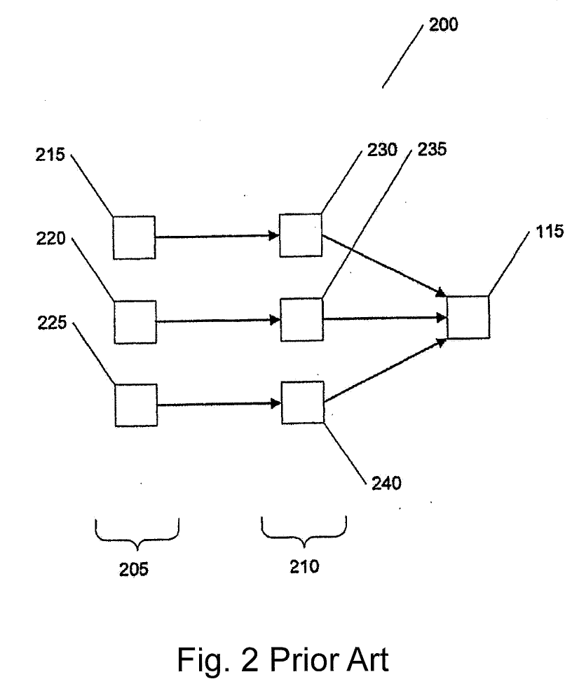

In the prior art process of FIG. 1, a customer 115 is able to receive a quotation for an insurance product or purchase an insurance product directly from a website belonging to an insurance product provider 105, an insurance product broker or aggregator 110. The provider website will sell the provider's insurance products directly to the customer 115. The broker website will act as an intermediary, and resell a provider's insurance products to the customer 115. The aggregator website 110, collates information belonging to one or more providers, presents the information for display to the customer 115 and either resells the provider's insurance products to the customer 115 or, for compensation, direct the customer 115 to the provider's or broker's website.

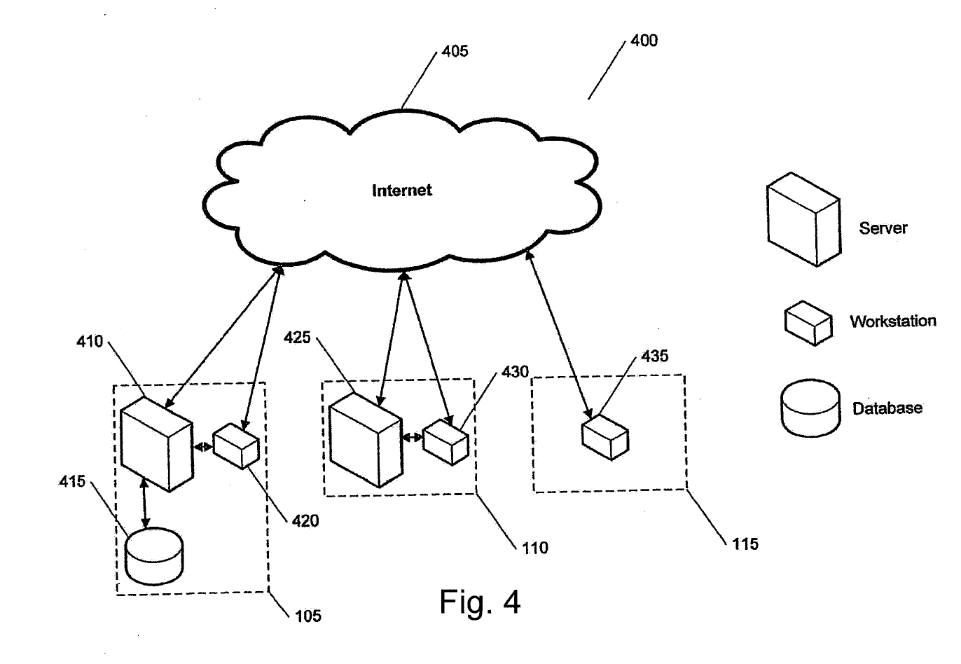

FIG. 4 shows a physical system 400 of the selling of insurance products via the Internet 405. In system 400, the provider 105 provides data related to insurance products via the Internet 405 using a web server 410 linked to a database 415. When the web server 410 receives a request via the Internet 405 for data related to an insurance product, the web server 410 retrieves data related to the insurance product from the database 415, constructs a web page comprising the retrieved data and serves the web page as a response to the request. The provider 105 is able to edit the data contained in the database 415 using input devices connected to the web server 410 or using a computer workstation 420.

In the system 400, the broker 110 provides data relating to the insurance products of the provider 105 via the Internet 405 by using a web server 425 of the broker 110. The broker may edit the data using input devices connected to the web server 425 or using a computer workstation 430.

Also, in the system 400, the customer 115 uses a computer workstation 435, or other device connected to the Internet 405, containing an Internet browser application to browse the Internet 405 to identify insurance products sold by one or more providers 105 or brokers 110. Once the customer 115 identifies an insurance product sold by a provider 105 or broker 110, the customer may then use the workstation 435 to request data related to the insurance product from the provider 105 or broker 110. In response to this request, the provider web server 410 or the broker web server 425 will serve a web page comprising data related to the requested insurance product. In a preferred implementation, the broker web server 425, when responding to a request for data related to an insurance product, will further request data related to the requested insurance product from the provider web server 410 and include the data received back from the provider web server 410 in the response to the customer 435.

In certain implementations, the broker 110 acts as an insurance product aggregator. In this instance, the broker web server 425 serves data related to insurance products from more than one provider 105.

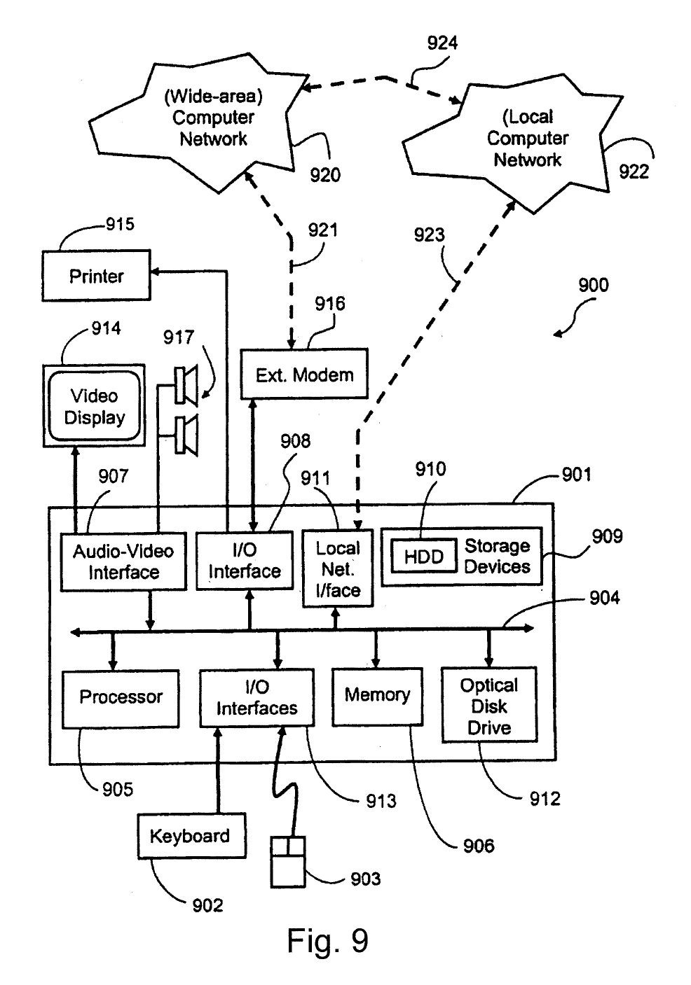

The computers 410-435 are typically general purpose computers configurable with the system 400 in a manner akin to that shown in FIG. 9 for a computer system 900. Specifically the system 900 may represent any one or more of the computers 410-435.

Once the customer workstation 435 receives data related to the requested insurance product, the customer 115 may then use the workstation 435 to purchase the insurance product in a manner known to those skilled in the art.

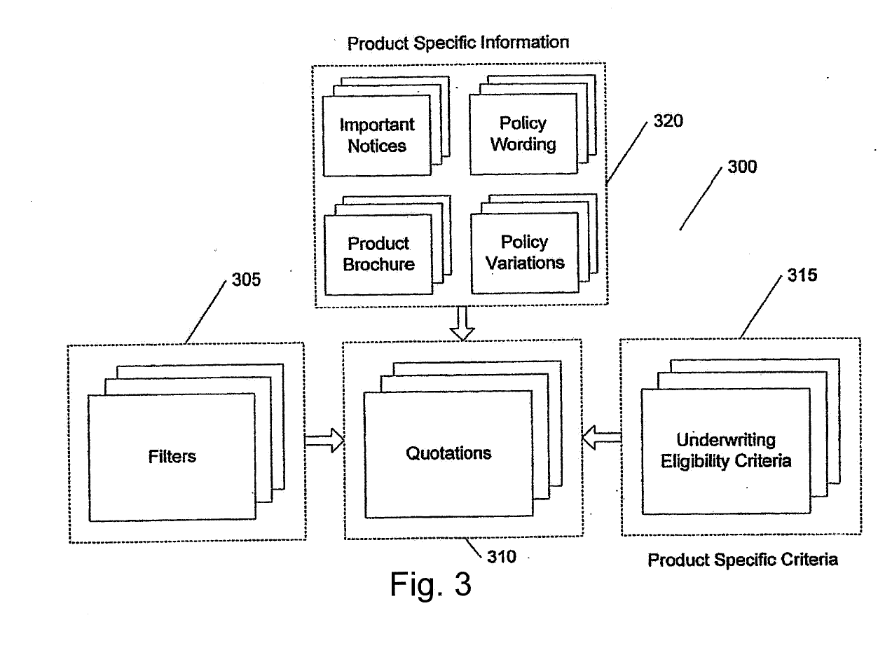

The presently disclosed methods of selling insurance products may be implemented using the computer system 900, wherein the processes of FIGS. 3 to 8 to be described may be implemented as software, such as one or more application programs typically executable within the system 900 when implemented as the web servers 410, 425. In particular, the steps of the present methods are effected by instructions in the software that are carried out within the computer system 900. The instructions may be formed as one or more code modules, each for performing one or more particular tasks.

The software may be executed on one or both of web servers 410, 425 to effect the steps of methods 600A-600D to be described, including receiving a request generated by an Internet browser application running on the customer workstation 435, querying the database 415 in response to the request, querying a further web server if necessary, processing the request, and outputting a response to be displayed in a graphical user interface (GUI) executed within an Internet browser application running on the customer workstation 435. The software may also be divided into two separate parts as follows: The first part and the corresponding code modules perform the web server 410, 425 and database 415 methods including receiving a request generated by the customer workstation 435, querying the database 415 in response to the request, querying a further web server if necessary, processing the request, and outputting a response to the customer workstation 435. The second part and the corresponding code modules manage the display of the GUI of the customer workstation 435 and the associated methods including, receiving input from the customer 115, outputting a request to one of web servers 410, 425, receiving the response from one of web servers 410, 425 and displaying the response. Typically, the first part is executable from one or both of the web servers 410 and 425 and the second part executes on the customer workstation 435. The software may be stored in a computer readable medium, including the storage devices described below, for example. The software is loaded into the computer system 900 from the computer readable medium, and then executed by the computer system 900. A computer readable medium having such software or computer program recorded on it is a computer program product. The use of the computer program product in the computer system 900, 410, 435 preferably effects an advantageous apparatus for selling insurance products. Subject to application programs executable therein, the computer system can be representative of the customer workstation 435.

As seen in FIG. 9, the computer system 900 is formed by a computer module 901, input devices such as a keyboard 902 and a mouse pointer device 903, and output devices including a printer 915, a display device 914 and loudspeakers 917. An external Modulator-Demodulator (Modem) transceiver device 916 may be used by the computer module 901 for communicating to and from a communications network 920 via a connection 921. The network 920 may be a wide-area network (WAN), such as the Internet or a private WAN. Where the connection 921 is a telephone line, the modem 916 may be a traditional “dial-up” modem. Alternatively, where the connection 921 is a high capacity (e.g., cable) connection, the modem 916 may be a broadband modem. A wireless modem may also be used for wireless connection to the network 920.

The computer module 901 typically includes at least one processor unit 905, and a memory unit 906, for example, formed from semiconductor random access memory (RAM) and read only memory (ROM). The module 901 also includes any number of input/output (I/O) interfaces including an audio-video interface 907 that couples to the video display 914 and loudspeakers 917, an I/O interface 913 for the keyboard 902 and mouse 903 and optionally a joystick (not illustrated), and an interface 908 for the external modem 916 and printer 915. In some implementations, the modem 916 may be incorporated within the computer module 901, for example within the interface 908. The computer module 901 also has a local network interface 911 which, via a connection 923, permits coupling of the computer system 900 to a local computer network 922, known as a Local Area Network (LAN). As also illustrated, the local network 922 may also couple to the wide network 920 via a connection 924, which would typically include a so-called “firewall” device or similar functionality. The interface 911 may be formed by an Ethernet™ circuit card, a wireless Bluetooth™ or an IEEE 802.11 wireless arrangement.

The interfaces 908 and 913 may afford both serial and parallel connectivity, the former typically being implemented according to the Universal Serial Bus (USB) standards and having corresponding USB connectors (not illustrated). Storage devices 909 are provided and typically include a hard disk drive (HDD) 910. Other devices such as a floppy disk drive and a magnetic tape drive (not illustrated) may also be used. An optical disk drive 912 is typically provided to act as a non-volatile source of data. Portable memory devices, such as optical disks (e.g., CD-ROM, DVD), USB-RAM, and floppy disks for example may then be used as appropriate sources of data to the system 900.

The components 905 to 913 of the computer module 901 typically communicate via an interconnected bus 904 and in a manner which results in a conventional mode of operation of the computer system 900 known to those in the relevant art. Examples of computers on which the described arrangements can be practiced include IBM-PC's and compatibles, Sun Sparcstations, Apple Mac™ or like computer systems evolved therefrom.

Typically, the application programs discussed above are resident on the hard disk drive 910 and read and controlled in execution by the processor 905. Intermediate storage of such programs and any data fetched from the networks 920 and 922 may be accomplished using the semiconductor memory 906, possibly in concert with the hard disk drive 910. In some instances, the application programs may be supplied to the user encoded on one or more CD-ROM and read via the corresponding drive 912, or alternatively may be read by the user from the networks 920 or 922. Still further, the software can also be loaded into the computer system 900 from other computer readable media. Computer readable media refers to any storage medium that participates in providing instructions and/or data to the computer system 900 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 901. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

The second part of the application programs and the corresponding code modules mentioned above may be executed to implement one or more graphical user interfaces to be rendered or otherwise represented upon a corresponding display 914 of the workstation 435. Through manipulation of the keyboard 902 and the mouse 903, the customer user of the computer system 900, 435 and a browser application may manipulate the interface to provide controlling commands and/or input to the applications associated with the GUI driven by the web servers 410, 425.

In a specific implementation, the quotation provided is pre-underwritten subject to certain eligibility criteria related to the insurance product. These “certain” criteria may be a specific subset of all criteria used in offering a product. In this manner, the broker 110 or customer 115 therefore does not need to request authorization from the provider 105. The provider 105 is able to provide a pre-underwritten quotation subject to the customer 115 confirming certain simple eligibility criteria. The provider 105 only requires the customer 115 to confirm the subset of criteria that are statistically significant to the risk profile of the customer 115 in order to provide the pre-underwritten quotation.

For example, in the case where the provider 105 is selling life insurance, the provider 105 may choose to disregard such criteria as the income or the profession of the customer 115 which may be only weakly correlated to life insurance risk, but may require the customer 115 to satisfy a threshold for criteria strongly correlated to life insurance risk, such as smoker or non-smoker, or age. In a specific implementation, the provider 105 can provide the pre-underwritten quotation to the customer 115 provided that the customer 115 confirms that, for example, he or she is a non-smoker and younger than 85 years of age. In this manner the disadvantages of the delay experienced when requesting underwriter authorization and delay caused when cover is declined are overcome.

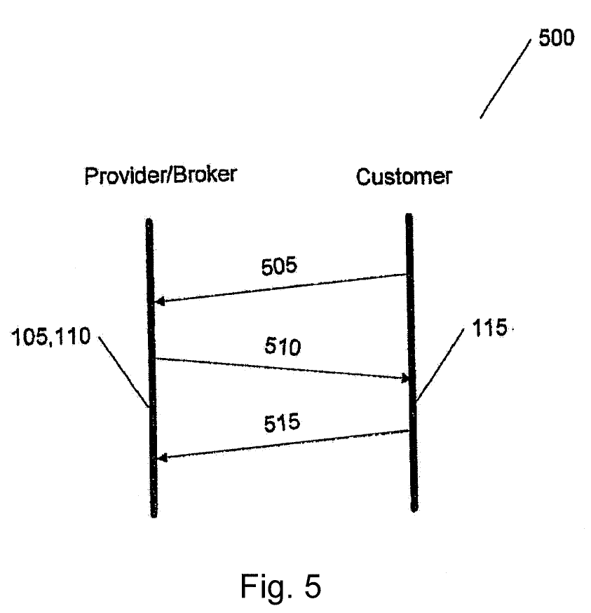

FIG. 5 shows the steps of process 500 where the customer 115 purchases an insurance product from a provider 105 or broker 115. The process 500 begins at step 505 when the customer 115 requests a quotation for an insurance product. At step 510 the provider 105 or broker 110 provides the requested quotation to the customer 510. At step 515 the customer 115 confirms the eligibility criteria and pays for the insurance product. The provider 105 or broker 110 then binds the insurance product.

Since the quotes are pre-underwritten subject to the customer 115 meeting the eligibility criteria as described above, the provider 105 is able to offer quotations for more than one insurance product.

For instance, in the case of the provider 105 selling leisure travel insurance, the usual questions which may include flight dates, medical history and customer 115 personal information may be discarded and replaced by eligibility criteria which state that the customer 115, for instance, must be less than 85 years of age.

For the case of the provider 105 selling car insurance, the usual questions which may include make and model of the car, street address where the car is parked and customer 115 personal information may be discarded and replaced with eligibility criteria which state that the customer 115, for instance, must be over 25 years of age and not use the car for business purposes.

In this manner, the provider 105 is able to provide quotations for more than one insurance product through the same graphical user interface, by inserting the eligibility criteria applicable to the requested insurance product into the GUI. In the same manner, so too can further information applicable to the insurance product be inserted into the GUI. This further information may include the product brochure, important notices, policy variations and the standard policy wording. Thus the disadvantage of the customer 115 being faced with a daunting array of GUIs when purchasing multiple insurance products is overcome.

In the described arrangement, the number of steps required to buy an insurance product remain consistent regardless of the insurance product type. In this manner, a wide variety of insurance products may be sold including combined management liability and professional indemnity insurance for Real Estate Agencies, contaminated products insurance, corporate travel insurance, crime insurance, directors' and officers' liability insurance for private and public unlisted companies, employment practice liability insurance, group personal accident insurance for most industries, householders' insurance, individual personal accident insurance, leisure travel insurance, machinery and equipment insurance, machinery and equipment insurance for specific industries, management liability insurance for associations, management liability insurance for hospitality venues, management liability insurance for most industries and professions (excluding financial institutions), management liability insurance for non-profits, management liability insurance for partnerships, marine cargo insurance for specific industries, motor vehicle fleet insurance, motor vehicle insurance, office package insurance (including but not limited to property, business interruption, liability and burglary insurance), product recall insurance, professional indemnity for management consultants, professional indemnity for personnel consultants, professional indemnity for real estate agents, professional indemnity for residential mortgage brokers, professional indemnity for travel agents, public and products insurance for low to medium risk industries and professions, retail and manufacturing package insurance for selected industries (including but not limited to property, business interruption, liability and burglary insurance) and term life insurance.

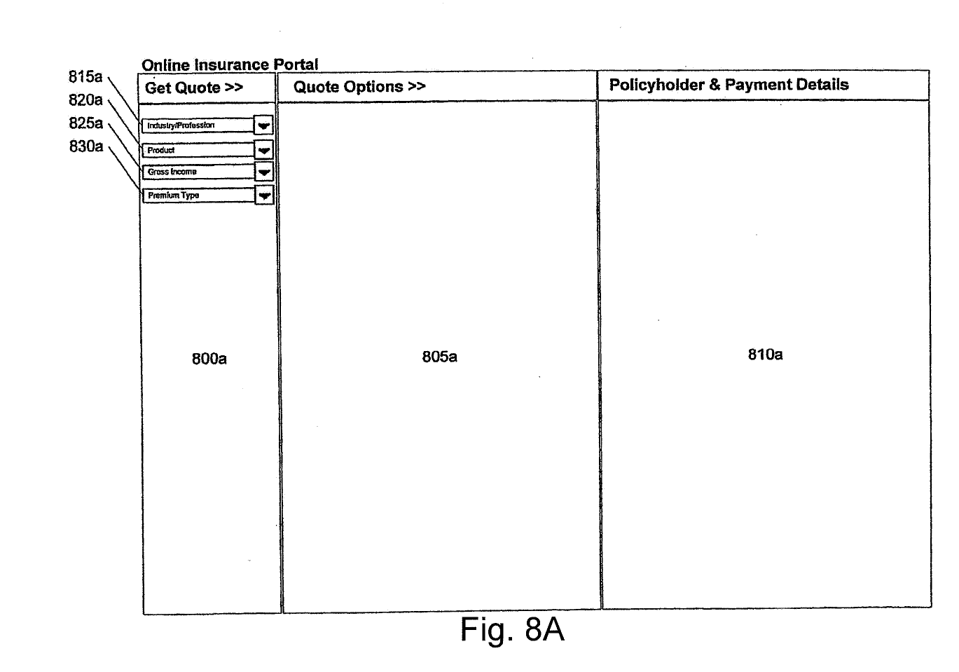

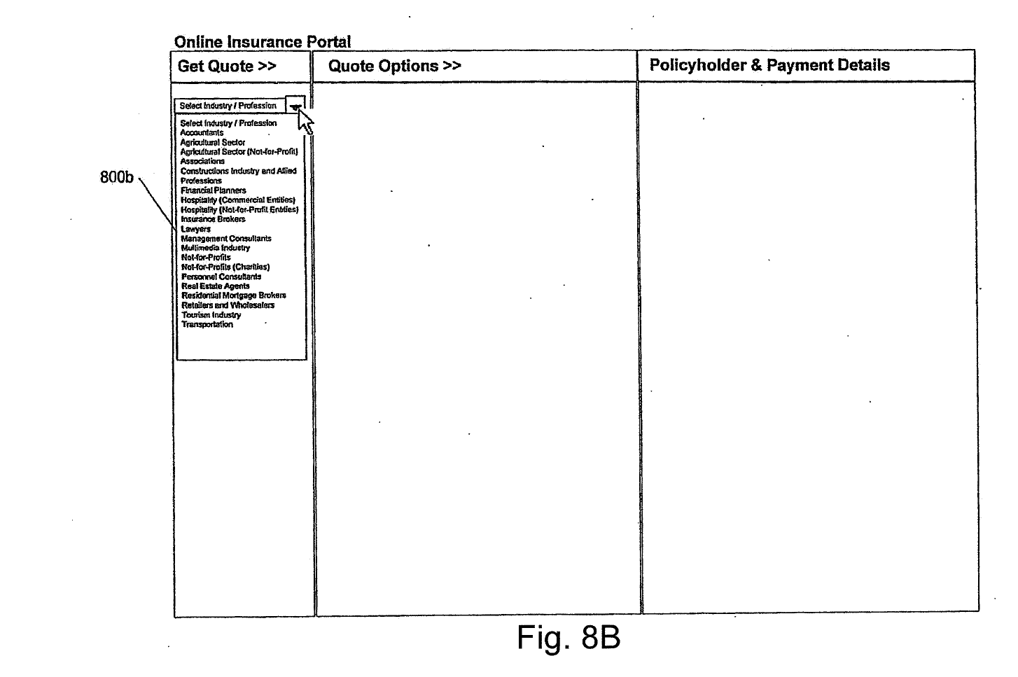

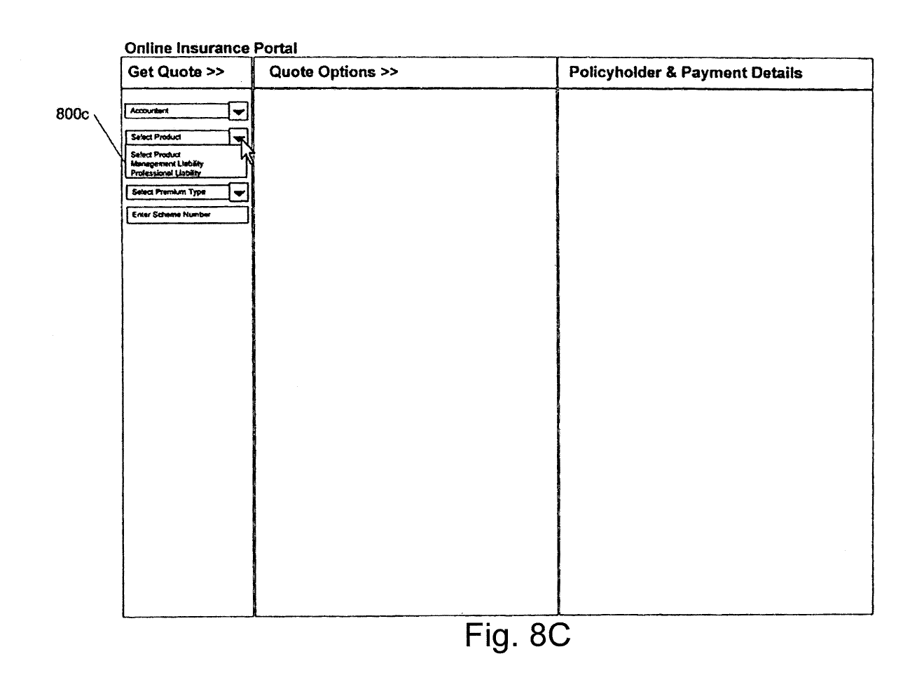

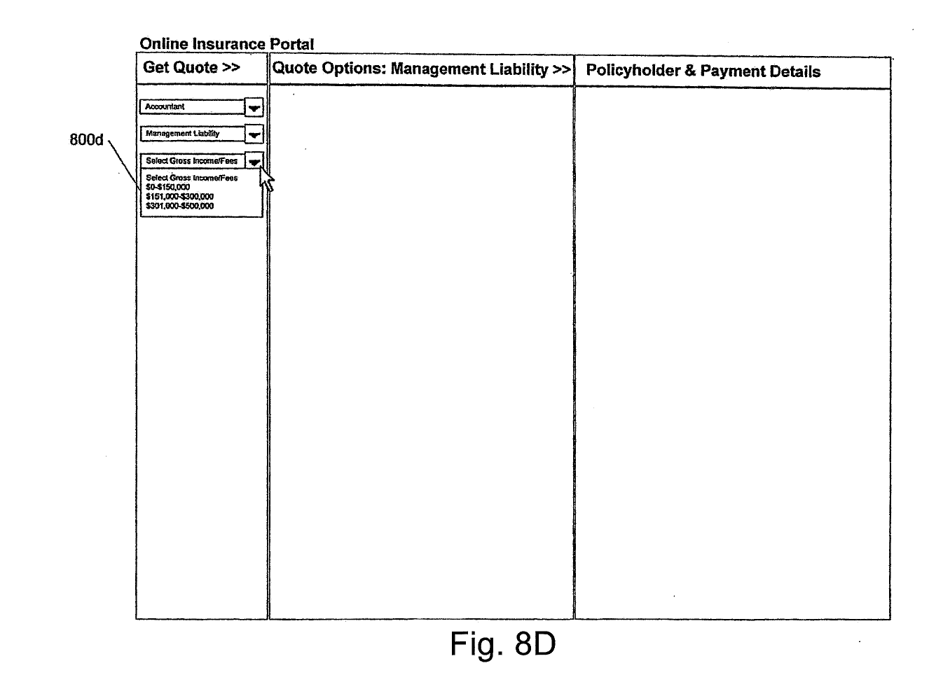

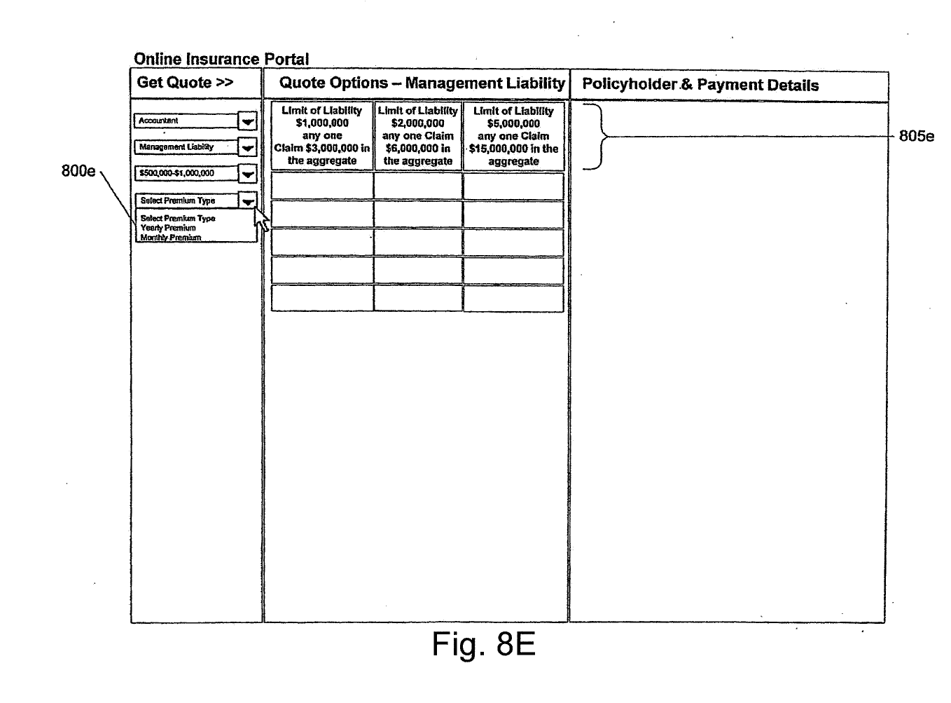

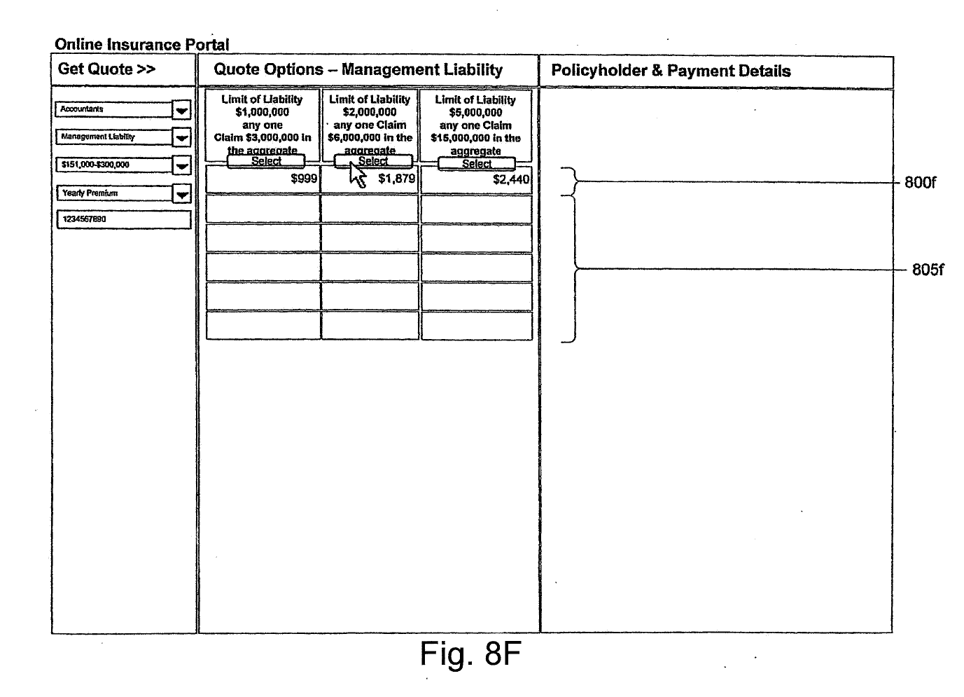

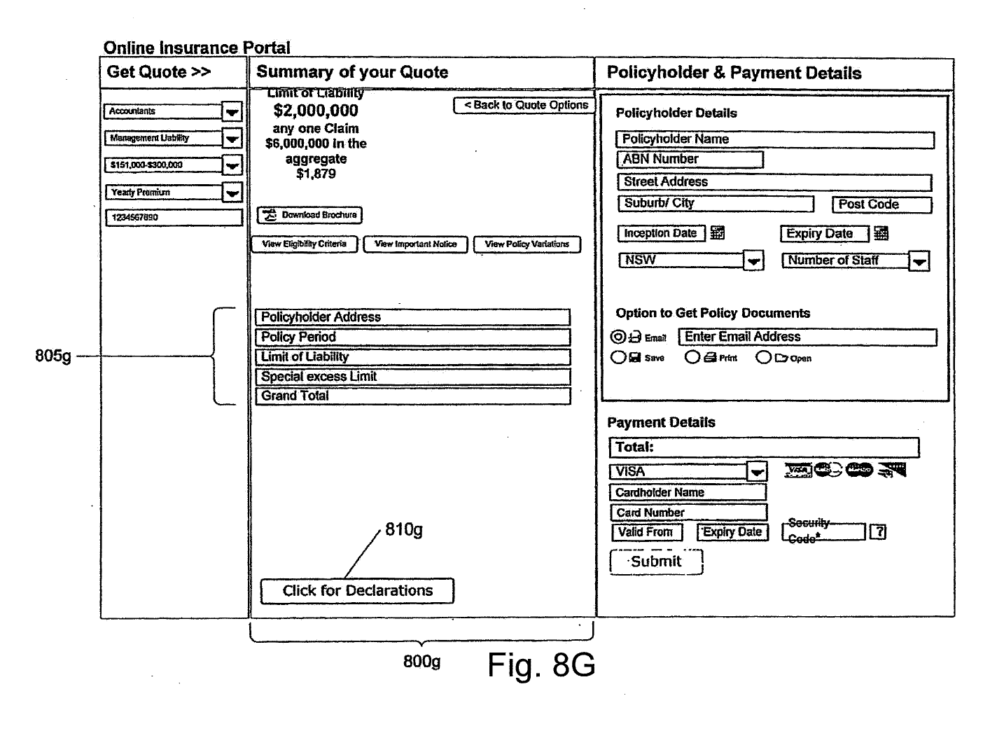

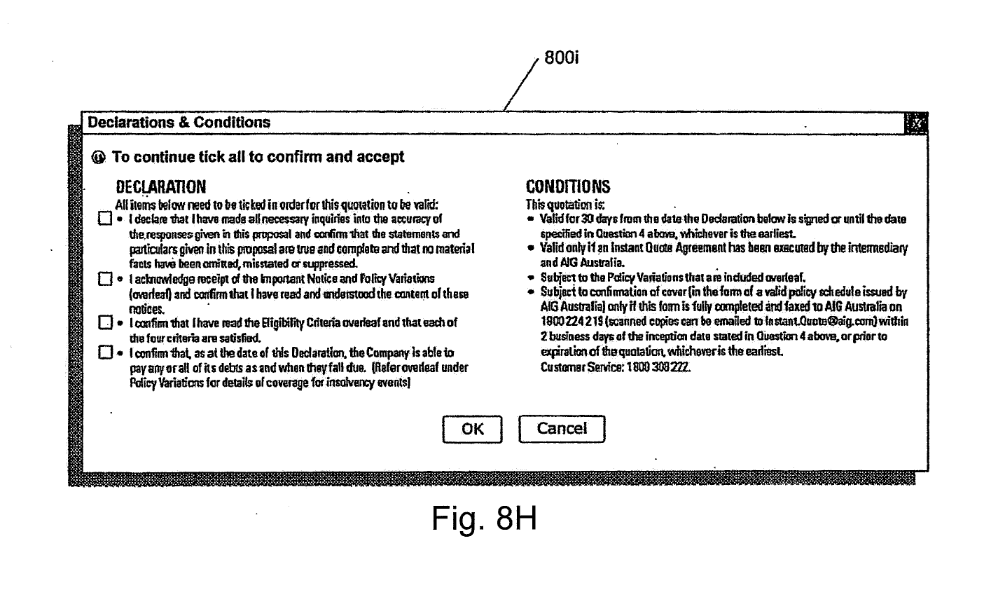

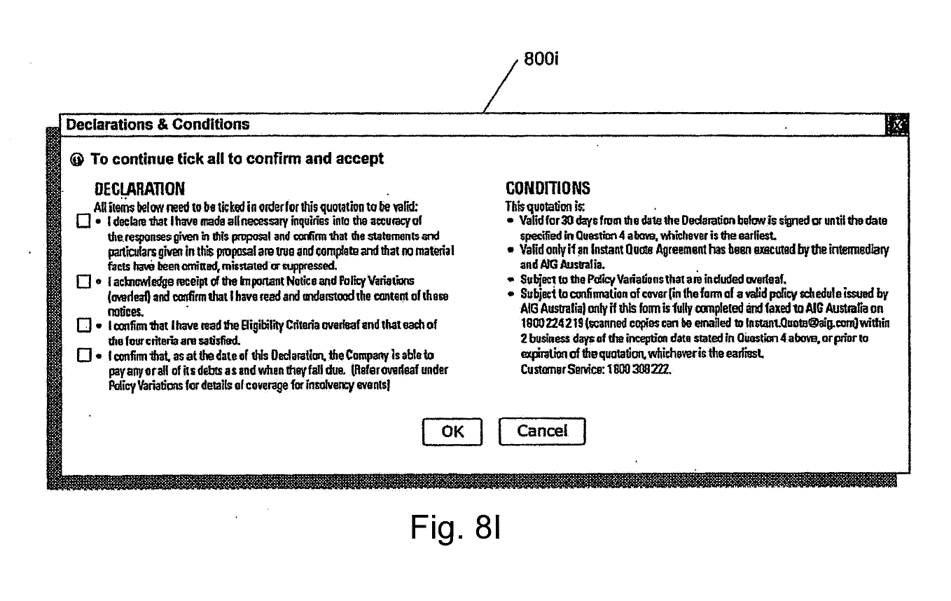

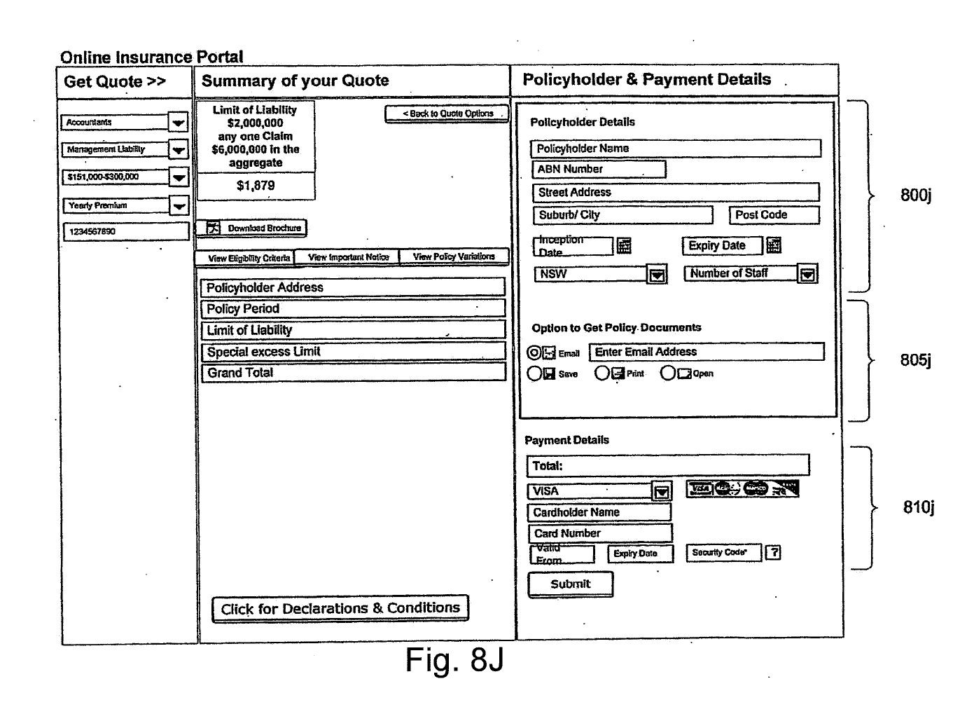

FIG. 3 is a schematic representation of the exemplary components of a system for selling insurance products, according to an aspect of the invention. FIG. 3 shows various standard elements that may be used to provide an insurance quotation. FIG. 3 relates to FIG. 8, which details the graphical user interface that is used to sell insurance products. In the system 300, the customer 115 selects the required insurance product using one or more insurance product filters 305. Once the insurance product has been identified, a quotation 310 is provided to the customer 115 containing information specific to the insurance product 320. Eligibility criteria 315 specific to the requested insurance product are then provided to the customer 115. Once the customer 115 has confirmed that they meet the eligibility criteria 315, the customer 115 is then able to pay the quotation amount to bind the insurance product.

The Product Specific Information (320) includes Important Notices, Policy Wording, Policy Variations, and Product Brochure. Important Notices are legal requirements with regard to a prospective policy holder's obligations with regard to disclosure and could also incorporate privacy notices, etc. A Policy wording is required for each insurance quotation and incorporates the base product prior to any customization or personalization. Policy variations capture any variations to the standard Policy Wording that may be applicable to the insurance quotation based on the selection of any of the filters 305, for example a particular endorsement may be applicable for a specific industry that either enhances or restricts the base cover in some way. The Product Brochure incorporates any marketing documentation or collateral specific to the product being sold.

Filters 305 refer to any of the factors that a user selects in order to provide more information regarding their industry type, product selection, rating parameters or premium basis (refer to 800a in FIG. 8A). The filters 305 are a standard to any user/risk being entered on the system and represents non-personal information that provides the selection of industries, products and other variables in order that pricing options can be presented to the user. Traditionally, online insurance systems do not distinguish between such “filter” information and user specific information and require the user to input details regarding both prior to offering a quotation.

Embodiments of the inventions comprise of a generic computer software framework for the presentation of all the elements of a quotation, regardless of the type of insurance product As a consequence, data related to multiple product lines, or products from multiple insurers can be presented together, using the same format and incorporated into the generic computer software framework. Multiple products presented in this way can be purchased simultaneously with a minimum of clicks and input of information by a user (i.e. no data input fields common to multiple products need to be duplicated).

The underwriting eligibility 315 refers to any underwriting criteria (including claims history) that are required to be satisfied prior to the quote being able to be bound. Although the exact underwriting criteria would vary by product and depending upon the industry, the intention of the system GUI is to always allow for some underwriting criteria to be stated during the course of every quotation with the content being able to vary depending upon the context. Conversely, traditional online quotation systems underwriting eligibility criteria or questions would typically be hard-coded for each and every product and would be required to be completed before a premium is quoted.

During a typical quotation process a user may select any number of filters (305) which specify the user's industry (if relevant), the products to be quoted, the rating drivers, and the basis of the premium (i.e. paid annually or monthly). The system may display a premium quotation (or a number of quotation options) (See 800f in FIG. 8F) based upon the applicable rating table and may provide links to the relevant Product Specific Information (320) If the user wishes to proceed with the quotation they are presented with the relevant Eligibility Criteria (315) and confirm that they meet the criteria (See 800i in FIG. 8I). If the user confirms that they meet the Eligibility Criteria the quotation is valid. The user may be requested to input personal and risk specific information and make payment (See 800j and 810j in FIG. 8J).

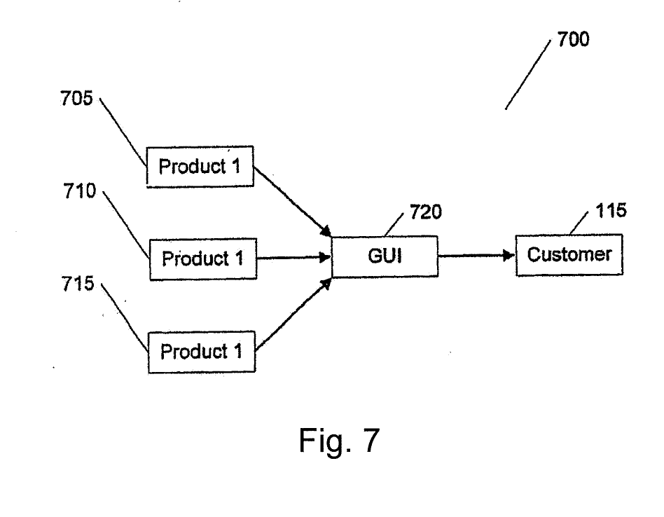

FIG. 7 schematically shows a system 700 for selling more than one insurance product 705, 710, 715 using a single GUI 720. The system 700 comprises one or more insurance products 705, 710, 715 and a single quotation GUI 720. In system 700, the customer 115 is able to use a single GUI 720 to purchase one or more insurance products 705, 710, 715. Desirably, the GUI 720 comprises data fields that remain the same for more than one insurance product and only the data contained in the data fields changes for different insurance products 705, 710,715.

The manner in which product information from more than one insurance product can be inserted into the single GUI 720 offers cost saving advantages for the provider 105. In the instance where the provider 105 offers a new insurance product to the market, the system 400 and methods 600a-600d of selling insurance products do not need to be altered or developed. The provider need only provide the necessary information pertaining to the product.

This is illustrated in the example where the provider 105 brings a new product to the market. The provider begins by making information pertaining to the new product available, typically by entering or uploading, by FTP, SQL queries or other means, data to the provider web server 410 or database 415. The information may include important notices, policy wording, product brochures or policy variations. In this manner, the provider 105 does not incur any additional system or development costs and is able to realize significant cost savings.

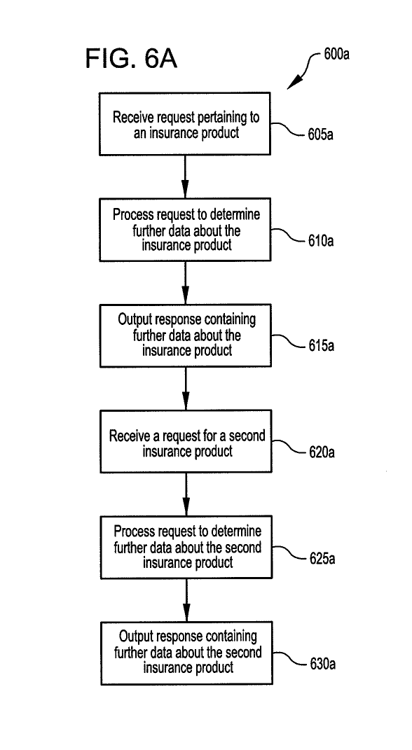

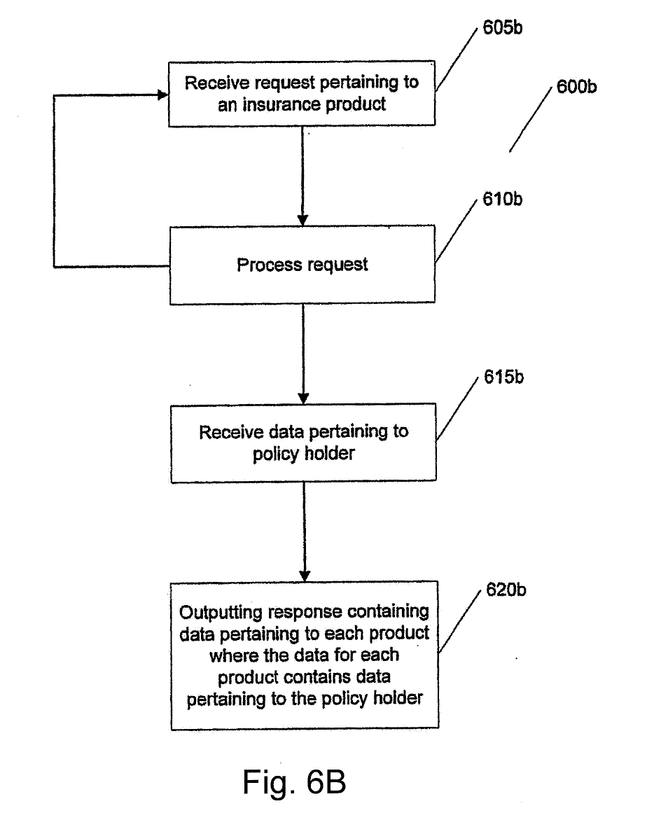

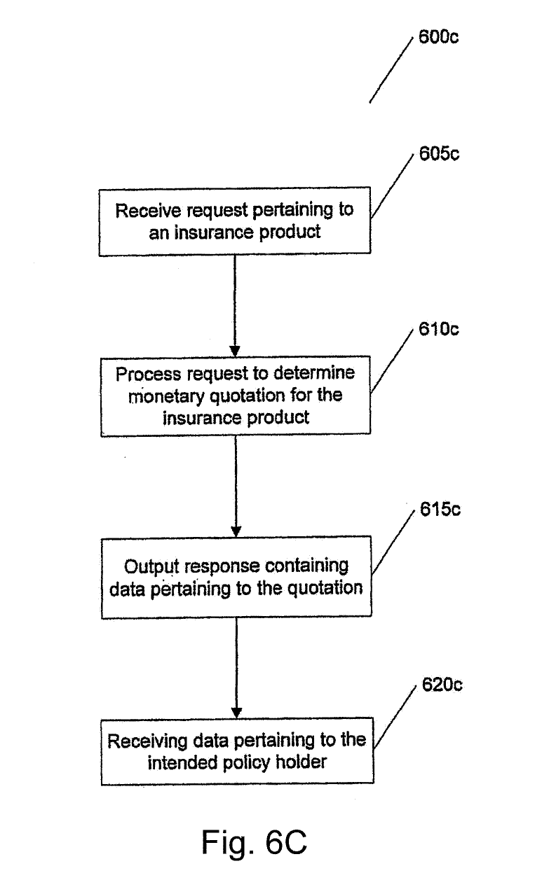

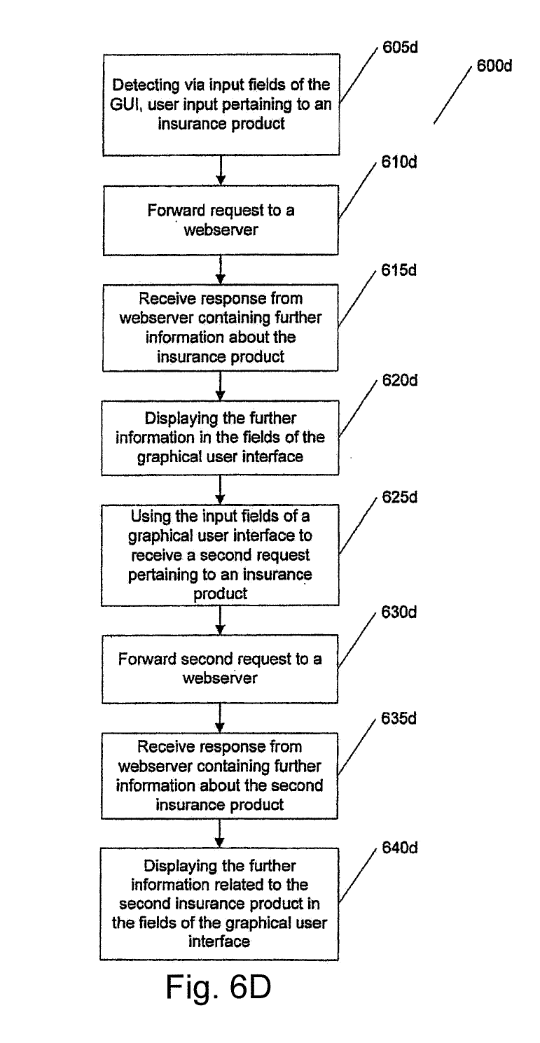

FIG. 6A shows the method 600a of the provider web server 410 receiving requests for an insurance product from a customer 115 and outputting responses to be displayed in the GUI 720 to the customer 115. The method 600a starts at step 605a where the web server 410 receives data pertaining to an insurance product that a customer 115 has entered into the GUI 720. In step 610a, the data is processed in order to determine further information about the requested insurance product. This information may contain information obtained from the database 415. In step 615a data containing further information about the requested insurance product is output as a response for display in the GUI 720 of the customer 115. In step 625a the web server 410 receives data pertaining to a second insurance product that a customer 115 has entered into the GUI 720. In step 625a, the data is processed in order to determine further information about the second requested insurance product. This information may also contain information obtained from the database 415. In step 630a data containing further information about the second requested insurance product is output as a response for display in the GUI of the customer 115.

The single GUI 720 to provide quotations for more than one insurance product described above provides the advantage of a single point of entry for customer 115 details. In this manner, the customer 115 is able to enter their details once for more than one insurance product. This is illustrated in the example in which a customer 115 buys crime insurance and personal accident insurance using the single GUI. The example starts where the customer 115 enters filter information to identify the crime insurance product. Once the product has been identified, information specific to the crime insurance product is inserted into the GUI 720. The customer 115 then confirms the eligibility criteria related to crime insurance. At this point, the customer 115 is able to use the product filters to identify personal accident insurance. Once the product has been identified, information specific to the personal accident insurance product is inserted into the GUI 720. The customer 115 then confirms the eligibility criteria related to personal accident insurance. It is only at this stage that the customer 115 is required to enter their personal information. This information is then copied to the crime policy and personal accident policy, removing the requirement for the customer 115 to enter their details twice.

FIG. 6B shows the method 600b of the provider web server 410 handling multiple requests containing data relating to insurance products that a customer 115 has entered or otherwise selected into the GUI 720. The method 600b starts at step 605b where the web server 410 receives a request containing data pertaining to an insurance product that a customer 115, has entered into the GUI 720. At step 610b the data is processed. At this point the web server 410 may receive another request for an insurance product that a customer 115 has entered into the GUI 720, whereby the method will go back to step 605b. At step 615b, the web server 415 receives data related to the intended policy holder that a customer 115 has entered into the GUI 720. At step 620b a response is outputted containing data relating to the requested insurance products for display in the GUI 720 of the customer 115 where the data relating to each insurance product contains the data related to the intended policy holder.

In the method of 600c, at step 605c the web server 410 receives a request containing data pertaining to an insurance product that a customer 115 has entered into the GUI 720. At step 610c the data is processed to determine at least a monetary quotation for the insurance product. At step 615c data pertaining to the monetary quotation is outputted for display in the GUI 720 of the customer 115. At step 620c the web server 410 receives data pertaining to the intended policy holder that a customer 115 has entered into the GUI 720.

FIG. 6D shows the method 600d of the GUI 720 outputting requests for an insurance product to a web server 410 and receiving responses for display from the web server 410. The method 600d starts at step 605d where the GUI 720 detects data pertaining to an insurance product that a customer 115 has entered. This may include simple selection of items displayed in the GUI, using drop down menus, or detecting the numeric data entry by the customer. In step 610d the data is sent to the web server 410. In step 615d data containing further information about the requested insurance product is received back from the web server 410. In step 620d the data containing further information is displayed for the customer 115 in the GUI 720. In step 625a the GUI 720 receives data pertaining to a second insurance product that a customer 115 has entered. In step 630d the data is sent to the web server 410. In step 635d data containing further information about the second requested insurance product is received back from the web server 410. In step 640d the data containing further information related to the second insurance product is displayed for the customer 115 in the GUI 720.

FIG. 8 shows an example of a GUI 720 to sell insurance products via the Internet 405. The GUI 720 is displayed on a display device of the workstation 435 by means of an Internet browser application. The GUI 720 has three main panels: a left panel 800a, a center panel 805a and a right panel 810a.

The customer 115 selects an insurance product using a series of drop down box filter fields 815a, 820a, 825a, 830a. Using the first drop down box 815a, the customer 115 selects their industry or profession from a predefined list 800b. For example, the customer 115 could select the accountant profession or the agricultural industry. Using the second drop down box 820a, the customer 115 identifies the particular insurance product desired from a predefined list 800c. For example, the customer 115 could request management liability, crime cover, employment liability or an office package. Using a third drop down box 825a, the customer 115 may specify the gross income from a predetermined list of ranges 800d. In the last drop down box 830a, the customer 115 identifies the premium type from a predetermined list 800e. For example, the customer 115 could select a yearly premium or a monthly premium.

Once the customer 115 has entered the insurance product filter information into the drop down boxes 815a, 820a, 825a, 830a, a number of quotes for the insurance product options 805e matching the filter information are displayed in the center panel 805a. In the preferred implementation, three product options 805e are displayed for different limits of liability. Information related to each option 805e is displayed including the pricing 800f and other information 805f relating to the option, including a product brochure, eligibility criteria, important notices and policy variations.

After the customer 115 has selected an option from the options 805e, a summary 800g of the selected option is displayed. Form 805g displays a plurality of read only customer detail fields. A button 810g causes a panel to show displaying the eligibility criteria 800h and the Declarations and Conditions 800i. Once the Declarations and Conditions 800i have been accepted, the customer 115 is able to use form 800j to enter their details including the inception and expiry date for the insurance product. At this point, the insurance product customer is able to purchase another insurance product in the same manner as described above.

Once the customer is finished purchasing insurance products, the option to select how the policy documents will be received is provided using form 805j. These options include email, save to a memory device, print, or display. Prior to payment, the read only fields 805g of the requested insurance products are updated with the customer 115 and details entered into form 800j. Using form 810j the customer 115 enters the payment information. After the customer 115 has input the required data, the data is sent to the provider web server 410 in order to bind the insurance product.

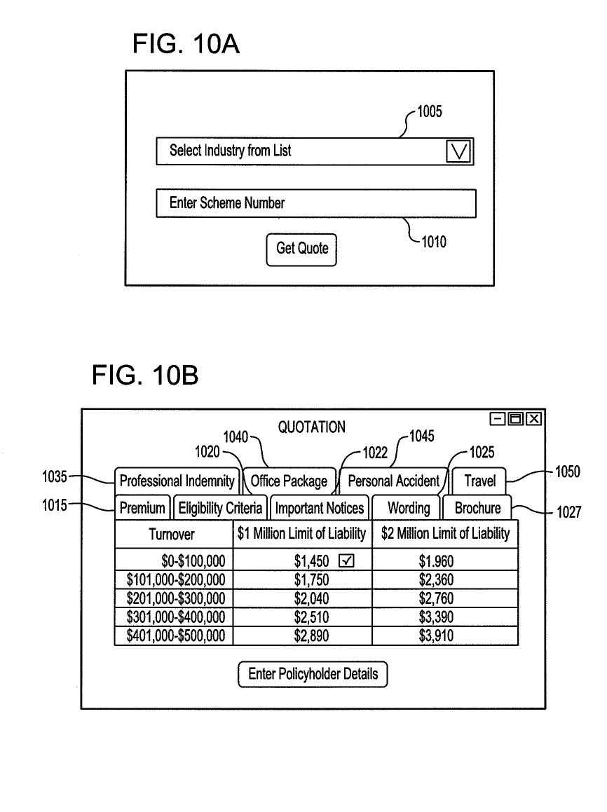

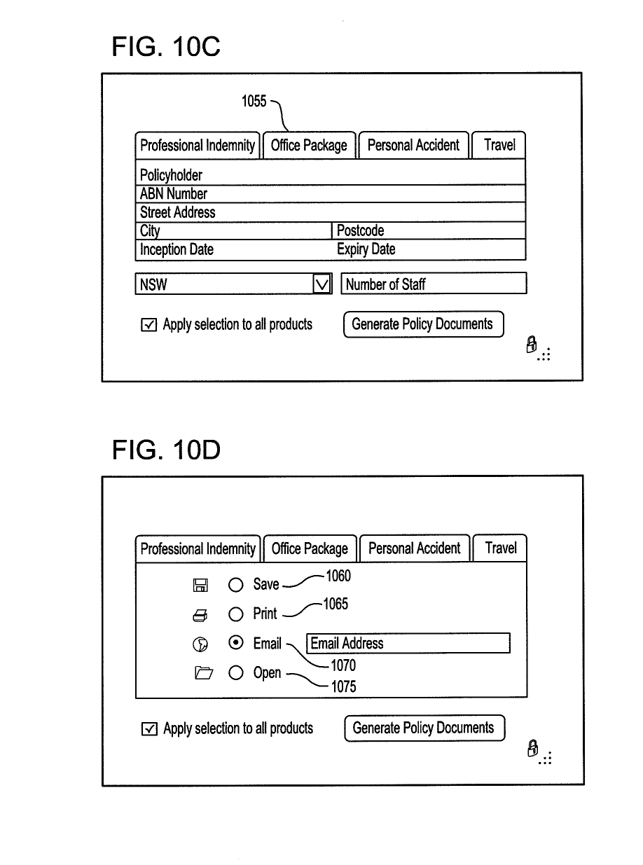

FIGS. 10A through 10D disclose another embodiment of a graphical user interface to sell insurance products via the Internet. FIG. 10A shows a first display that provides a field to enter the name of the Industry 1005 or Scheme number 1010. The customer 115 selects an insurance product/industry using a drop down box filter field 1005. Using the drop down box 1005, the customer selects their industry or profession from a predefined list. As mentioned in a previous example, the customer could select the accountant profession or the agricultural industry. Using the second drop down box 1010, the customer identifies the particular insurance product/scheme desired from a predefined list. For example, the customer could request management liability, crime cover, employment liability or an office package. After selecting an item in each drop down list (1005, 1010), a customer can click the “Get Quote” push button on the display to access the display shown in FIG. 10B.

FIG. 10B shows a second display that provides a quotation of the premium of selected products 1015. Once the customer has entered the insurance product/industry filter information into the drop down boxes in FIG. 10A, information relating to a number of insurance product options matching the filter information are displayed on the display. In FIG. 10B, four product options, Professional Indemnity 1035, Office Package 1040, Personal Accident 1045 and Travel 1050 are displayed. Further information such as the premium for different limits of liability of each insurance product is shown on the display. In addition, information related to each product option is displayed including eligibility criteria of a product 1020, important notices 1022, wording of a policy 1025, product brochure 1027. After selecting all the appropriate items, such as the premium of each insurance product, a customer can click the “Enter Policyholder Details” push button to access the display shown in FIG. 10C.

FIG. 10C is a display that allows a user to enter the policyholder details for each product. The customer is able to use the graphical user interface to enter their details such as their address as well as the inception and expiry date for the insurance product. Thereafter, the customer can click the “Generate Policy Documents” push button to access the display shown in FIG. 10D.

Once the customer is finished purchasing insurance products, the option to select how the policy documents may be received is provided using FIG. 10D. These options include email 1070, save to a memory device 1060, print 1065, or open 1075.

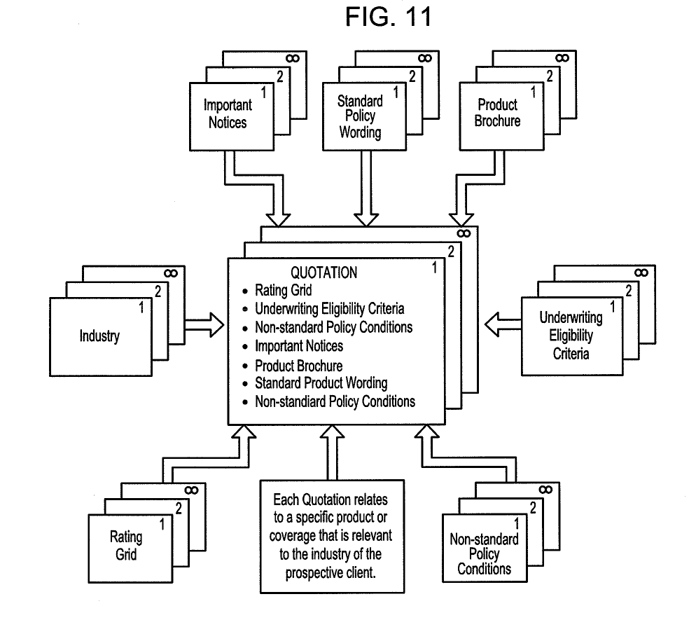

FIG. 11 shows a system to provide quotations for insurance products or sell insurance products. In the system, the customer selects the required insurance product using one or more insurance product filters (such as an industry filter). Once the insurance product has been identified, a quotation is provided to the customer containing information specific to the insurance product in the form of a Rating Grid. A Rating Grid shows the premium for different limits of liability for an insurance product. A customer may select a quotation from the Rating Grid. Eligibility criteria specific to the requested insurance product may then be provided to the customer. Once the customer has confirmed that they meet the eligibility criteria, the customer is then able to pay the quotation amount to bind the insurance product. In addition, the customer can review further information of the product including the Standard Policy Wording, the Nonstandard Conditions, the Important Notices, and the Product Brochure.

A significant benefit provided by aspects of the invention is that, because of the generic computer structure and framework which applies to all products (Refer to FIGS. 3 and 11), it is scalable with a minimum of new development work required to add new products. In order to provide for these benefits, an aspect of the invention may include a computer software framework and an administrative interface. The functionality of the computer software framework and the administrative interface may include a field to enter the name of the industry under consideration (See 815a in FIG. 8A), a field to enter product names applicable to the industry (See 820a in FIG. 8A), and a field to enter the rating drivers/parameters for each applicable product (See 825a in FIG. 8A). Further functionality of the computer software framework and the administrative interface may include fields to enter the column and row names for the premium rating table (See 805e in FIG. 8E). The system allows for a flexible number of rows and columns. The computer software framework and the administrative interface may include further fields to enter the premiums in the resultant grid (See 800f in FIG. 8F). The framework and the interface may also include a field to confirm which premium modes are allowed for this product (i.e. annual, monthly or some other time period or arrangement). The computer software framework and the administrative interface may upload the following in a pre-determined (non-editable) format: Important Notices, Eligibility Criteria, Policy wording, Applicable variations to the standard policy document, Customer brochure. In addition, an administrative interface may have a facility to choose an existing policy schedule format or an editor to map Policyholder details (See 800j in FIG. 8J) to the relevant fields in the applicable policy schedule.

Embodiments of the system may then effectively compile the above components into additional products for different industries or professions which can be tested before deployment and substantially reduce the time and cost to market for new products. A person of ordinary skill in the art would recognize that the above description is purely illustrative and that additional fields or options may be implemented depending upon the complexity and functionality of the computer software framework and the graphical user interface. In certain implementations, the single GUI 720 may be used by insurance product aggregators. In this method, the GUI 720 is used to provide quotations for insurance products or sell insurance products from one or more insurance product providers. In the preferred implementation, the insurance product providers will provide compensation to the aggregator.

It is apparent from the above that the arrangements described are applicable to the insurance industry.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including,” and not “consisting only of.” Variations of the word “comprising,” such as “comprise” and “comprises” have correspondingly varied meanings.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A computer system for selling an insurance product, the computer system comprising:
a web server;
one or more software applications running on at least the web server for utilizing at least one of a plurality of data fields and presenting one or more web pages to a user; and
a database for storing data relating to one or more insurance products;
wherein at least one of the one or more software applications is configured to serve a first web page comprising one or more eligibility criteria to a user, receive a confirmation from the user that the user meets the eligibility criteria, receive payment information from the user, and in response to receipt of the payment information, bind the insurance product.

2. The computer system according to claim 1, wherein the plurality of data fields are selected from the group consisting of a data field to specify an industry, a data field for a product name, a data field for the rating parameters, one or more data fields for a premium rating table, a data field for important notices, a data field for eligibility criteria, a data field for policy wording, a data field for policy variations, and a data field for a product brochure.

3. The computer system according to claim 1, the system further comprising at least one software application of the one or more software applications that chooses an existing policy schedule format.

4. The computer system according to claim 1, the system further comprising at least one software application of the one or more software applications that maps a policy holder detailed information to relevant data fields in a policy schedule.

5. The computer system according to claim 1, wherein at least one software application of the one or more software applications, implemented by the web server, transmits a second web page to a user that allows the user to select a filter to display one or more insurance products, and to select at least one of the insurance products, the second web page further allows the user to enter limited risk criteria associated with each selected insurance product.

6. The computer system according to claim 1, wherein the web server receives the data associated with the selected insurance product and the limited risk criteria and serves a web page to the user comprising a quote for each selected insurance product and the web server receives personal information and payment information and processes the payment information.

7. The computer system according to claim 1, the system further comprising a communication network that is connected to the web server.

8. A computer implemented method for selling an insurance product, the method comprising the steps of:
providing a computer software framework on a web server, the computer software framework having a plurality of data fields;
entering insurance product data into at least one of the plurality of data fields from a database storing insurance product data wherein one of the data fields is for an eligibility criterion for an insurance product;
serving at least one web page by a web server to a user, wherein the at least one web page comprising the insurance product data;
serving at least one web page by a web server to a user comprising the eligibility criterion for the insurance product;
receiving a confirmation from the user by the web server that the user meets the eligibility criterion for the insurance product;
receiving payment information from the user by the web server; and
binding the insurance product by the web server.

9. The computer implemented method according to claim 8, the method further comprising the steps of:
(a) receiving a first request comprising data pertaining to a first insurance product from a user by the web server;
(b) processing the first request to determine data related to said first insurance product by the web server;
(c) outputting a first response comprising data related to the first insurance product to be inserted into the data fields of a first web page to the user;
(d) receiving a second request comprising data pertaining to a second insurance product from the user by the web server;
(e) processing said second request to determine data related to the second insurance product by the web server; and
(f) outputting a second response comprising data related to said second insurance product to be inserted into the data fields of a second web page.

10. The computer implemented method according to claim 8, wherein the plurality of data fields are selected from the group consisting of a data field to specify an industry, a data field for a product name, a data field for the rating parameters, one or more data fields for a premium rating table, a data field for important notices, a data field for eligibility criteria, a data field for policy wording, a data field for policy variations, and a data field for a product brochure.

11. The computer implemented method according to claim 9, the method further comprising the step of serving a third web page comprising a monetary quotation for each insurance product.

12. The computer implemented method according to claim 8, the method further comprising the step of choosing an existing policy schedule format.

13. The computer implemented method according to claim 8, the method further comprising the step of mapping a policy holder detailed information to relevant data fields in a policy schedule.

14. A computer-readable medium having thereon computer-executable instructions for selling an insurance product, the computer-executable instructions comprising of:
instructions for providing a computer software framework on a web server, the computer software framework having a plurality of data fields;
instructions for entering insurance product data into at least one of the plurality of data fields from a database storing insurance product data wherein one of the data fields is for an eligibility criterion for an insurance product;
instructions for serving at least one web page by a web server to a user, wherein the at least one web page comprising the insurance product data;
instructions for serving at least one web page by a web server to a user comprising the eligibility criterion for the insurance product;
instructions for receiving a confirmation from the user by the web server that the user meets the eligibility criterion for the insurance product;
instructions for receiving payment information from the user by the web server; and
instructions for binding the insurance product by the web server.

15. The computer-readable medium according to claim 14, the computer-executable instructions further comprising:
(a) instructions for receiving a first request comprising data pertaining to a first insurance product from a user by the web server;
(b) instructions for processing the first request to determine data related to said first insurance product by the web server;
(c) instructions for outputting a first response comprising data related to the first insurance product to be inserted into the data fields of a first web page to the user;
(d) instructions for receiving a second request comprising data pertaining to a second insurance product from the user by the web server;
(e) instructions for processing said second request to determine data related to the second insurance product by the web server; and
(f) instructions for outputting a second response comprising data related to said second insurance product to be inserted into the data fields of a second web page.

16. The computer-readable medium according to claim 14, wherein the plurality of data fields are selected from the group consisting of a data field to specify an industry, a data field for a product name, a data field for the rating parameters, one or more data fields for a premium rating table, a data field for important notices, a data field for eligibility criteria, a data field for policy wording, a data field for policy variations, and a data field for a product brochure.

17. The computer-readable medium according to claim 15, the computer-executable instructions further comprising instructions for serving a third web page comprising a monetary quotation for each insurance product.

18. The computer-readable medium according to claim 14, the computer-executable instructions further comprising instructions for choosing an existing policy schedule format.

19. The computer-readable medium according to claim 14, the computer-executable instructions further comprising instructions for mapping a policyholder detailed information to relevant data fields in a policy schedule.
